(19) United States
(12) Patent Application Publication
(10) Pub. No.: US 2007/0211289 A1
(43) Pub. Date: Sep. 13, 2007

(54) PRINT PROGRAM, INFORMATION RECORDING MEDIUM AND PRINT SYSTEM

(75) Inventor: Kiyotsugu TAKIGUCHI, Chiryu-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/685,293

(22) Filed: Mar. 13, 2007

(30) Foreign Application Priority Data
Mar. 13, 2006 (JP) 2006-67692

(51) Int. Cl. G06K 15/00

(52) U.S. Cl. 358/1.16

(57) ABSTRACT

A method for making a computer device function as a print data generation module and a relevant information generation module is described. The method may be stored on computer-readable medium. The print data generation module creates print data based on target data to be stored on a storage unit. The relevant information generation module creates relevant information that associates the target data with the print data, to be stored on the storage unit.

### CROSS-REFERENCE TO RELATED APPLICATIONS

This application claims the benefit of Japanese Patent Application No. 2006-67692 filed Mar. 13, 2006 in the Japan Patent Office, the disclosure of which is incorporated herein by reference.

### BACKGROUND

Aspects of the present invention relate to a computer-related method implemented on a computer device and a computer-related medium that stores a program relating to the method.

Conventionally, to print target data such as a document created by an application software like a word processing program installed on a computer device, a print command must be sent from the application software by which the target data is created.

That is, a print command issued by an application software is transmitted to a print program on a computer device via an operating system (OS) installed on the computer device. Then, the print program creates print data based on the target data to be transmitted to a printer.

As above, in order to print the target data, a print command must be sent from the application software by which the target data is edited. There is a problem that reprinting operation is inconvenient.

In recent years, however, there is a print system that allows direct printing of once-created print data. In direct printing, it is not necessary to send a print command from an application software by which the target data is created.

However, the aforementioned print system only allows reprinting of the once-created print data without a print command from the application software by which the target data corresponding to the print data is created. Apparently, the print data is not utilized in a sufficiently effective manner.

### SUMMARY

It would be desirable to enhance utility (availability) of the once-created print data so as to improve usability of the print program.

It is desirable that a print program may make a computer device function as a print data generation module and a relevant information generation module. The print data generation module may create print data based on target data to be stored on a storage unit. The relevant information generation module may create relevant information that associates the target data with the print data, to be stored on the storage unit.

In the above, the “print data” includes printer specific data as well as print data described in “DETAILED DESCRIPTION OF THE PREFERRED EMBODIMENT” to follow. That is, the “print data” means data for printing created based on the target data either directly or indirectly.

### BRIEF DESCRIPTION OF THE DRAWINGS

The invention will now be described below, by way of example, with reference to the accompanying drawings, in which:

FIG. 1 is a diagram showing a print system according to embodiments;

FIG. 2 is a flowchart showing a main control flow according to a first embodiment;

FIG. 3 is a flowchart showing a print setting window process according to the embodiments;

FIG. 4 is a flowchart showing a print process according to the first embodiment;

FIG. 5 shows an example of a print setting window;

FIG. 6 is a flowchart showing a control flow when the print program according to the first embodiment is started alone;

FIG. 7 shows an example of a print monitor window according to the embodiments;

FIG. 8 shows an example of a notification window according to the embodiments;

FIG. 9 is a flowchart showing a control flow when a print program according to a second embodiment is started alone;

FIG. 10 shows an example of a selection window according to the second embodiment; and

FIG. 11 is a flowchart showing a control flow of a print process according to a third embodiment.

### DETAILED DESCRIPTION OF THE PREFERRED EMBODIMENT

In aspects of the various embodiments, a computer-related method according to various embodiments and related computer mediums storing a program with instructions for implementing the computer-related method according to aspects of the present embodiments is installed on a computer device connected to a printer. As a result, the computer device and the printer are made to function as a print system.

(First Embodiment)

1. Overview of Print System

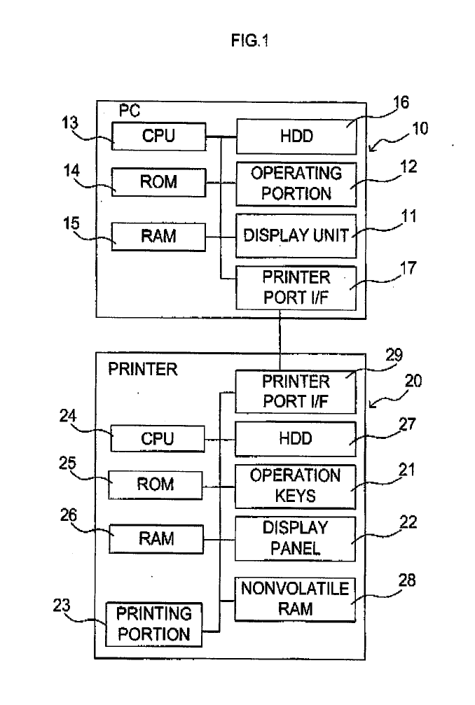

Referring to FIG. 1, a print system of the present embodiment is provided with a computer device (hereinafter, referred to as a PC) 10 and a printer 20 connected to the PC 10.

The PC 10 is identical with a known computer in structure. Particularly, the PC 10 includes a display unit 11, an operating portion 12, a CPU (Central Processing Unit) 13, a ROM (Read Only Memory) 14, a RAM (Random Access Memory) 15, a HDD (Hard Disk Drive) 16, and a printer port I/F (Interface) 17. The display unit 11 includes a LCD (Liquid Crystal Display) or a CRT (Cathode Ray Tube) for displaying images and characters. The operating portion 12 includes a not shown mouse and a not shown keyboard for moving a not shown pointer for use in pointing a specific region on the display unit 11. The ROM 14 includes a rewritable semiconductor memory device like a flash memory. The printer port I/F 17 is for use in connecting the printer 20 to the PC 10.

An operating system is installed on the PC 10. The operating system offers basic functions commonly used in many of application softwares. For example, the operating system provides input and output functions like input from the keyboard and output to the display unit 11. The operating system also provides a managing function like reading and writing from and to the ROM 14, the RAM 15 and the HDD16.

The printer 20 according to the present embodiment includes operation keys 21, a display panel 22, a printing portion 23, a CPU 24, a ROM 25, a RAM 26, a HDD 27, a nonvolatile RAM 28, and a printer port I/F 29. The operation keys 21 are used for selection of functions provided in the printer 20. The display panel 22 displays operation parameters and work performance. The printing portion 23 prints characters and images onto a recording medium such as paper. The volatile RAM 28 is capable of maintaining memory contents even in the case of power cut. The printer port I/F 29 directly connects the printer 20 to the PC 10.

2. Operation of Print Program (Print System)

A print program is a kind of a device driver that controls operation of the PC 10 and the printer 20 in cooperation with the operating system. The print program according to the present embodiment may be started in response to a print command from an application software or may be started alone.

The print program according to the present embodiment is installed on the HDD 16 via an information recording medium (for instance, a computer-readable medium) like a CD-ROM or a communication line like the Internet. The print program is read from the HDD 16 to the RAM 15 so as to be operated at startup.

2.1. Startup in Response to Print Command from Application Software

2.1.1. Main Control Flow

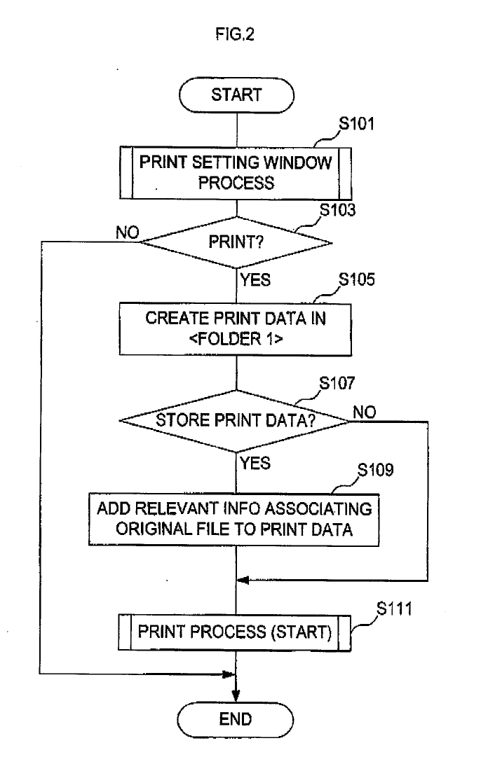

A main control flow shown in FIG. 2 is started when a command for printing target data such as document data and drawing data is issued from an application software capable of creating the target data.

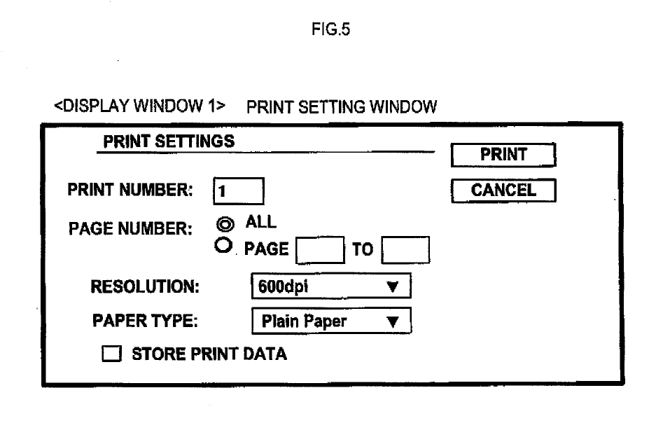

When the main control flow is started, firstly a control flow for a print setting window process is started to display a print setting window (FIG. 5) on the display unit 11 (S101).

The print setting window as shown in FIG. 5, for example, shows a plurality of types of setting parameters such as the number of prints, page numbers of the target data to be printed, resolution at printing, type of recording paper, and selection on whether to store the print data after printed. A user can set these parameters using the mouse and the keyboard.

When the print setting window is shown on the display unit 11, it is determined in the main control flow (FIG. 2) which of a “print” setting control or a “cancel” setting control in the print setting window is selected by the user, that is, whether or not to execute printing (S103). If it is determined that the “cancel” setting control is selected (S103: NO), the main control flow is ended.

On the other hand, if it is determined that the “print” setting control is selected (S103: YES), print data is generated based on the target data and stored on a first region (hereinafter, referred to as a folder 1) on the HDD 16 (S105).

The print data herein corresponds to work data (work file) generated based on the target data before generation of later explained printer specific data.

Next, it is determined whether to store the print data after printed on the HDD 16 based on selection made in the print setting window (S107). If it is determined that the print data is to be stored (S107: YES), relevant information is generated which associates the target data to the print data created based on the target data, and the print data with the relevant information is stored in the folder 1 as a spool file (S109).

The relevant information here means information including at least (1) a file name of the target data, (2) a stored place of the target data, (3) revised date and time of the target data, and (4) a type of the application software by which the target data is created. The relevant information may include at least one of the above information (1) to (4).

In the present embodiment, the revised date and time of the target data are stored as date and time of creation of the spool file. The application software in use when a start command for the main control flow is received is stored as the application software by which the target data is created.

After the step of S109, or when it is determined in S107 that the print data is not to be stored (S107: NO), a print process is executed (S111). Details of the print process will be described later.

2.1.2. Print Setting Window Process

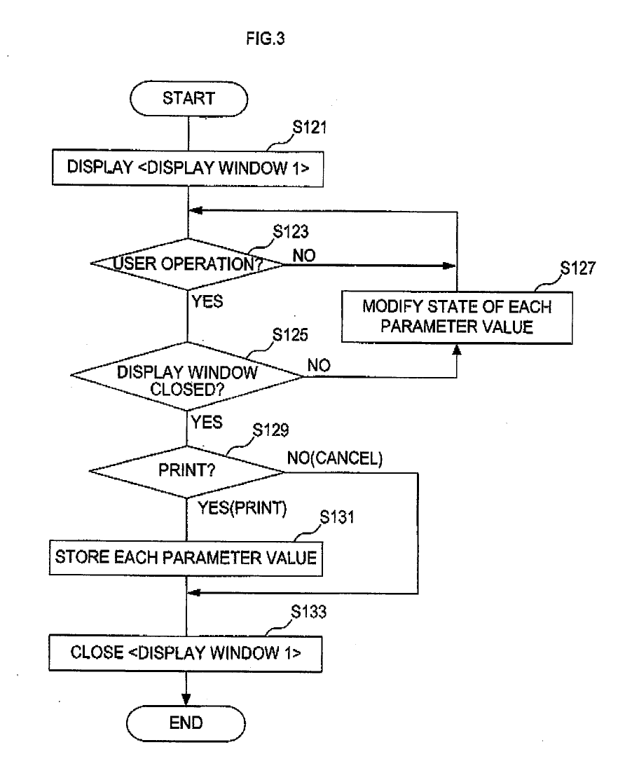

Referring to FIG. 3, when a control flow of the print setting window process is started, a display window 1 (i.e., print setting window in FIG. 5) is displayed on the display unit 11 (S121). It is then determined in S123 whether there is user operation to a setting control such as for the number of prints or resolution at printing. The step of S123 is repeated until there is user operation to a setting control.

If it is determined in S123 that there is user operation to a setting control (S123: YES), it is determined whether the operated setting control is a “print” setting control or a “cancel” setting control, that is whether or not the display window 1 is closed (S125).

When it is determined in S125 that the display window 1 is not closed (S125: NO), the parameter value of the operated setting control is changed to the displayed parameter value (S127). On the other hand, if it is determined in S125 that the display window 1 is closed (S125: YES), it is determined in S129 which of the “print” setting control or the “cancel” setting control is operated, that is, whether or not to execute printing.

When it is determined in S129 that the “print” setting control is operated to execute printing (S129: YES), the parameter value in the operated setting control is updated and stored in a predetermined region in the HDD 16 (S131). The display window 1 is closed to end the present control flow (S133).

When it is determined in S129 that the “cancel” setting control is operated so as not to execute printing (S129: NO), the display window 1 is closed to end he present control flow (S133).

2.1.3. Print Process

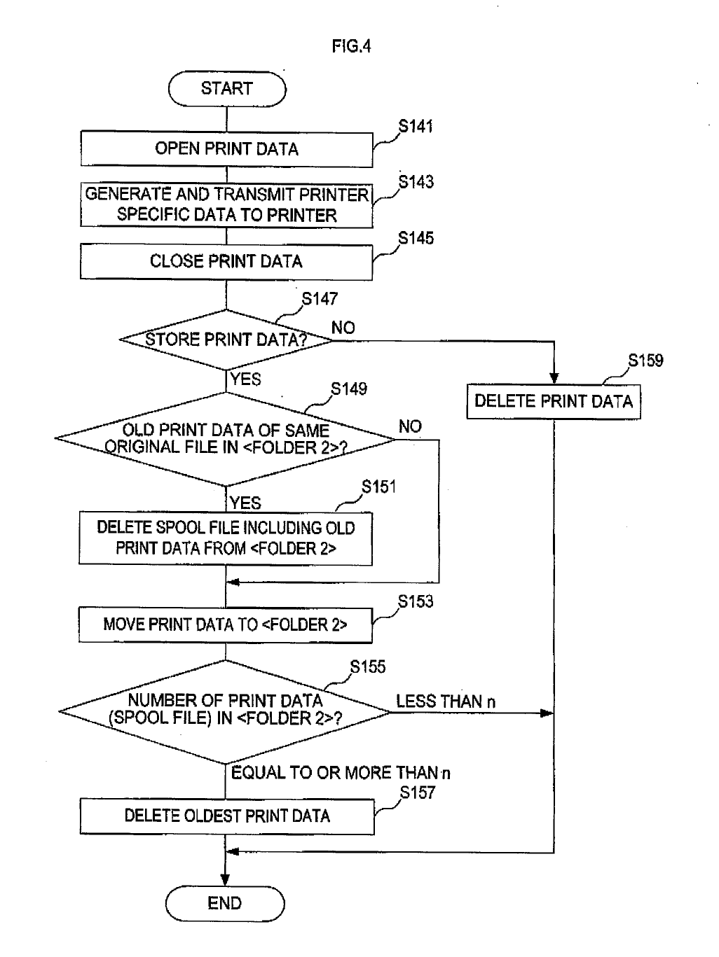

Referring to FIG. 4, when a control flow of the print process is started, firstly, the print data is opened (S141). The print data is converted to printer specific data that can be interpreted by the printer 20 connected to the PC 10. Then, the printer specific data is transmitted to the printer 20 (S143).

When the printer specific data is transmitted and printing is ended, the print data is closed (S145). It is determined whether to store the print data after printed on the HDD 16 based on the storage selection made in the print setting window (S147).

If it is determined in S147 that the print data is to be stored (S147: YES), it is determined whether there is a spool file already stored in a second predetermined region (hereinafter, referred to as a folder 2) on the HDD 16 which includes print data created based on the target data (hereinafter, referred to as an original file) corresponding to the print data to be stored (S149).

If it is positively determined in S149 (S149: YES), the already stored spool file is removed (S15 1). The spool file including the print data and closed in S145 is moved from the folder 1 to the folder 2 to be stored (S153).

Next, it is determined whether there are a predetermined number of or more than n spool files stored in the folder 2 (S155). If it is positively determined in S155 (S155: YES), a spool file having the oldest date and time of creation is removed out of all the spool files in the folder 2 (S157). The present control flow is ended. In S157, if there are a plurality of the spool files having the oldest date and time of creation, at least one or all of those files may be removed.

On the other hand, if it is negatively determined in S155 (S155: NO), none of the spool files is removed in the folder 2. The control flow is ended.

2.2. Lone Startup of Print Program

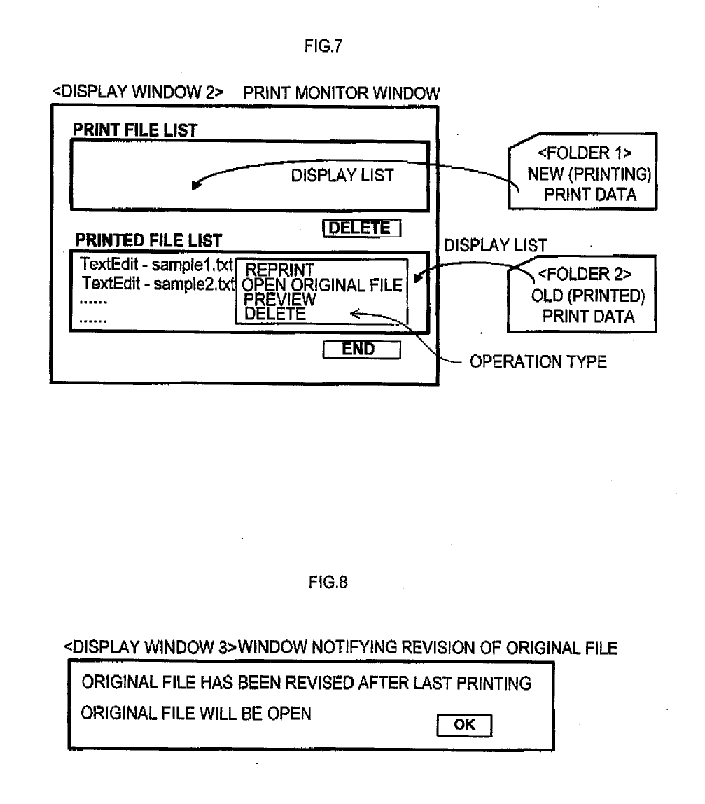

In FIG. 7, the print data stored in the folder 1, that is, a list of the print data in printing is shown in the upper part (print file list) of a print monitor window. The print data stored in the folder 2, that is, a list of the print data which has been printed at least once is shown in the lower part (printed file list) of the print monitor window.

The print data herein includes a spool file that is print data to which the relevant information is attached, if not otherwise specified.

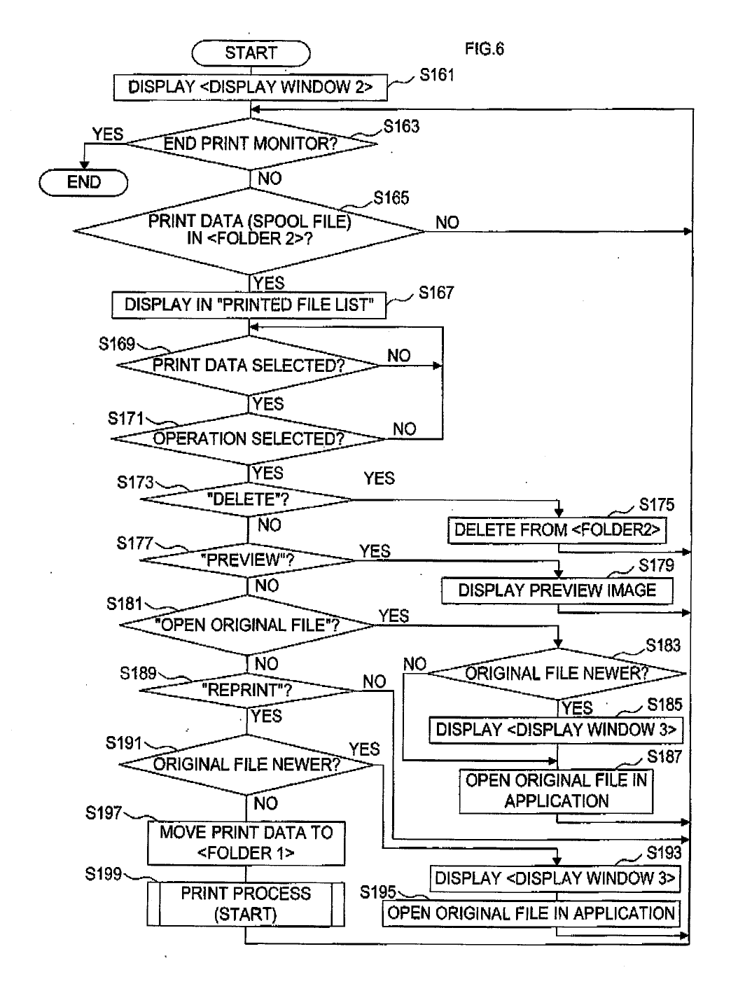

Referring to FIG. 6, when the print program is started, firstly a display window 2 (i.e., print monitor window in FIG. 7) is displayed on the display unit 11 (S161). It is then determined whether to end display of the print monitor window, that is, whether or not an “end” setting control is selected in the print monitor window (S163).

If it is determined in S163 that the “end” setting control is selected (S163: YES), the present control flow is ended. Otherwise (S163: NO), it is determined whether there is print data in the folder 2 (S165).

If it is determined in S165 that there is no print data in the folder 2 (S165: NO), the control flow returns to S163. If it is determined that there is print data in the folder 2 (S165: YES), all the print data in the folder 2 is displayed on the printed file list (S167).

Next, it is determined whether any of the print data displayed in the printed file list is selected by a pointer (S169). If positively determined in S169 (S169: YES), types of operations (see FIG. 7) are displayed which can be performed on the selected print data, and it is further determined whether any of the displayed operations is selected (S171).

In the present embodiment, the operations to be performed are “reprint”, “open original”, “preview” and “remove” operations. The “reprint” operation allows printing of the selected print data without starting an application software. The “open original” operation allows opening of the original file in an application software by which the original file can be edited. The “preview” operation allows advance viewing (preview) of a printed image of the selected print data on the display unit 11. The “remove” operation allows removal of the selected print data from the folder 2.

When it is determined in S169 that none of the print data is selected from the printed file list (S169: NO), or when it is determined in S171 that none of the displayed operations is selected (S171: NO), the control flow returns to S169. When it is determined in S171 that any of the displayed operations is selected (S171: YES), it is further determined whether the selected operation is the “remove” operation (S173).

If it is positively determined in S173 (S173: YES), the selected print data is removed from the folder 2 (S175). The control flow returns to S163. Otherwise (S175: NO), it is determined whether the “preview” operation is selected (S177).

When it is positively determined in S177 (S177: YES), the selected print data is shown as a preview image on the display unit 11 (S179). Otherwise (S177: NO), it is determined whether the “open original” operation is selected (S181).

If it is positively determined in S181 (S181: YES), it is further determined whether the original file is newer than the selected data, that is, whether the original file is revised after creation of the print data, based on the revised date and time of the original file and the creation date and time of the selected print data (S183).

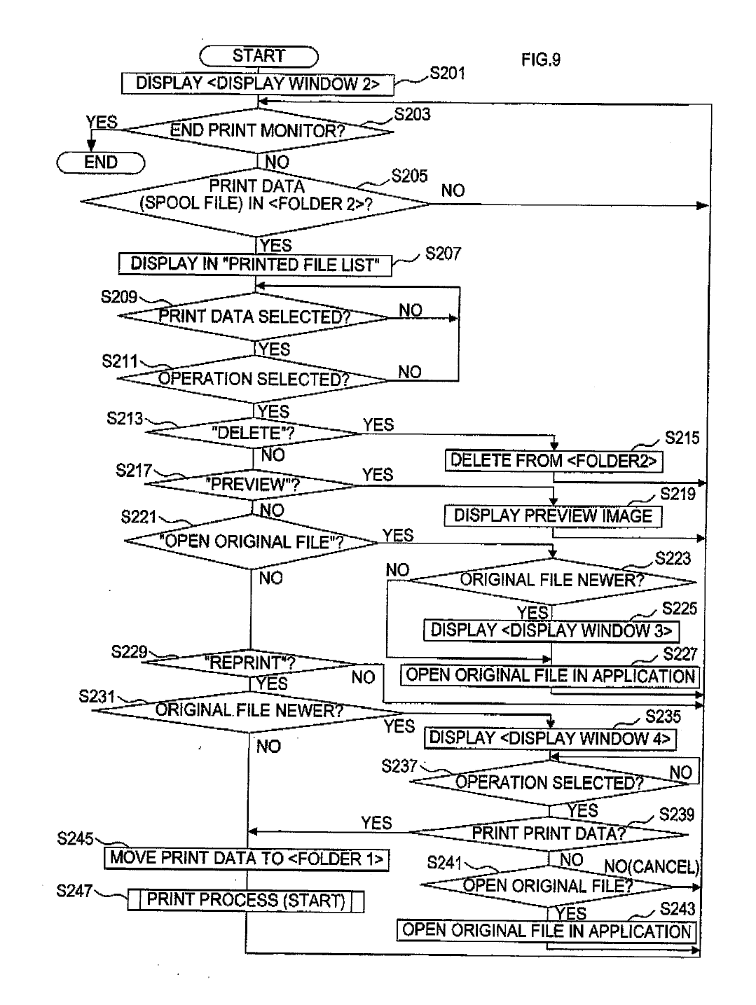

If it is determined in S183 that the original file is newer than the selected print data (S183: YES), the user is notified of revision of the original file e.g., through a display window 3 shown in FIG. 8 on the display unit 11 (S185). Then, the original file is opened in an application software by which the original file can be edited (S187). The control flow returns to S163.

If it is determined in S183 that the original file is not newer than the selected print data, that is, the original file is not revised after the creation date and time of the print data (S183: NO), the original file is opened in an application software by which the original file can be edited (S187). The display window 3 does not appear on the display unit 11. The control flow returns to S163.

When it is determined in S181 that the “open original” operation is not selected (S181: NO), it is further determined whether the “reprint” operation is selected (S189). If it is determined in S189 that the “reprint” operation is not selected (S189: NO), the control flow returns to S163.

When it is determined in S189 that the “reprint” operation is selected (S189: YES), it is further determined whether the original file is newer than the selected data, that is, whether the original file is revised after the creation of the print data, based on the revised date and time of the original file and the creation date and time of the selected print data (S191).

If it is determined in S191 that the original file is newer than the selected print data (S191: YES), the user is notified of revision of the original file e.g., through a display window 3 shown in FIG. 8 on the display unit 11 (S193). Then, the original file is opened in an application software by which the original file can be edited (S195). The control flow returns to S163.

If it is determined in S191 that the original file is not newer than the selected print data, that is, the original file is not revised after the creation date and time of the print data (S191: NO), the selected print data is moved to the folder 1 (S197). The display window 3 does not appear on the display unit 11. The selected print data is printed in the print process shown in FIG. 4 (S199). The control flow returns to S163.

3. Characteristics of Print Program according to First Embodiment

In the present embodiment, when print data is generated, that is, when a command for printing the print data is issued in an application software, relative information is generated which associates the print data with the target data (original file).

Accordingly, information can be easily obtained on whether the target data is revised after creation of the print data as noted above. Utility of the print program can be improved.

Furthermore, the original file can be automatically opened in an editable manner based on the relative information. Thus, it is not necessary for the user to search for a suitable application software by which the original file of the print data can be edited. Utility of the print program can be improved.

According to the print program of the present embodiment, reprinting of the print data corresponding to the original file can be performed without opening the original file in an application software by which the original file can be edited. Accordingly, utility of the print program can be further improved.

Reprinting is performed without opening the original file by a suitable application software when it is determined that the original file is not revised. Therefore, the user is free from the trouble of checking whether or not the original file is revised upon reprinting.

The original file, if revised, is automatically opened in a suitable application software by which the original file can be edited. Therefore, reprinting can be avoided of old data before the revision. Utility of the print program is further improved.

When there is equal to or more than a predetermined number of print data stored in the folder 2, the print data is removed in the order of oldness so that the number of print data stored in the folder 2 is less than the predetermined number. Thus, unnecessary accumulation of print data can be avoided in the folder 2.

A preview image of the print data can be displayed on the display unit 11 at reprinting. Thus, the user can check the printed image before actual printing of the print data. Utility of the print program is further enhanced.

It is also determined whether or not to remove the print data after printed. Thus, unnecessary accumulation of the print data can be avoided in the folder 2.

(Second Embodiment)

In the first embodiment, the original file is automatically opened, when it is determined at the “reprint” operation that the original file is newer than the print data. However, in the second embodiment, the user can choose whether to open the original file in an application software or to reprint the selected print data as is, when it is determined at the “reprint” operation that the original file is newer than the print data.

The second embodiment is only different from the first embodiment in the control steps performed when the print program is started alone. Therefore, only the difference will be described hereinafter.

1.Lone Startup of Print Program

Referring to FIG. 9, when a print program according to the second embodiment is started, firstly the display window 2 (i.e., print monitor window in FIG. 7) is displayed on the display unit 11 (S201). It is then determined whether the “end” setting control is selected in the print monitor window (S203).

If it is determined in S203 that the “end” setting control is selected (S203: YES), the present control flow is ended. Otherwise (S203: NO), it is determined whether there is print data in the folder 2 (S205).

If it is determined in S205 that there is no print data in the folder 2 (S205: NO), the control flow returns to S203. If it is determined that there is print data in the folder 2, all the print data in the folder 2 is displayed on the printed file list (S207).

Next, it is determined whether any of the print data displayed on the printed file list is selected by a pointer (S209). If positively determined in S209 (S209: YES), types of operations (see FIG. 7) are displayed which can be performed to the selected print data, and it is further determined whether any of the displayed operations is selected (S211).

When it is determined in S209 that none of the print data is selected on the printed file list (S209: NO), or when it is determined in S211 that none of the displayed operations is selected (S211: NO), the control flow returns to S209. When it is determined in S211 that any of the displayed operations is selected (S211: YES), it is further determined whether the selected operation is the “remove” operation (S213).

If it is determined in S213 that the “remove” operation is selected (S213: YES), the selected print data is removed from the folder 2 (S215). The control flow returns to S203. Otherwise (S215: NO), it is determined whether the “preview” operation is selected (S217).

When it is determined in S217 that the “preview” operation is selected (S217: YES), the selected print data is shown as a preview image on the display unit 11 (S219). Otherwise (S217: NO), it is determined whether the “open original” operation is selected (S221).

If it is determined in S221 that the “open original” operation is selected (S221: YES), it is further determined whether the original file is newer than the selected data, based on the revision date and time of the original file and the creation date and time of the selected print data (S223).

If it is determined in S223 that the original file is newer than the selected print data (S223: YES), the user is notified of revision of the original file e.g., through a display window 3 shown in FIG. 8 on the display unit 11 (S225). Then, the original file is opened in an application software by which the original file can be edited (S227). The control flow returns to S203.

If it is determined in S223 that the original file is not newer than the selected print data (S223: NO), the original file is opened in an application software by which the original file can be edited (S227). The display window 3 does not appear on the display unit 11. The control flow returns to S203.

When it is determined in S181 that the “open original” operation is not selected (S221: NO), it is further determined whether the “reprint” operation is selected (S229). If it is determined in S229 that the “reprint” operation is not selected (S229: NO), the control flow returns to S203.

When it is determined in S229 that the “reprint” operation is selected (S229: YES), it is further determined whether the original file is newer than the selected data, based on the revision date and time of the original file and the creation date and time of the selected print data (S231).

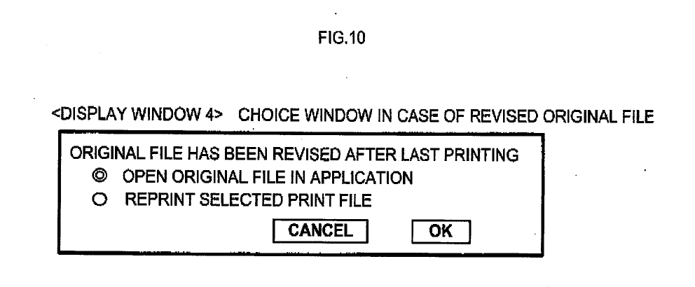

If it is determined in S231 that the original file is newer than the selected print data (S231: YES), the user is urged to choose between opening the original file in an application software by which the original file can be edited and reprinting the selected print data as is e.g., through a display window 4 shown in FIG. 10 on the display unit 11 (S235).

That is, selectable operation functions such as “open original” and “reprint” are displayed on the display window 4. It is determined whether one of the operation functions is selected on the display window 4 (S237). If it is determined in S237 that one of the operation functions is selected (S237: YES), it is further determined whether the selected function is the “reprint” function (S239).

If it is determined in S239 that the selected function is the “reprint” function (S239: YES), the selected print data is moved to the folder 1 (S245). The print data is printed in the print process shown in FIG. 4 (S247). The control flow returns to S203.

On the other hand, if it is determined in S239 that the “reprint” function is not selected (S239: NO), it is further determined whether the “open original” function is selected (S241). If positively determined in S241 (S241: YES), the original file is opened in an application software by which the original file can be edited (S243). The control flow returns to S203.

On the other hand, if it is negatively determined in S241 (S241: NO), the display window 4 is closed. The control flow returns to S203.

2. Characteristics of Print Program According to Second Embodiment

In the present embodiment, when it is determined that the original file is revised, the user is urged to choose whether or not to open the original file in a suitable application software by which the original file can be edited. Therefore, the user can avoid reprinting the old print data without knowing that the original file is revised. Utility of the print program is much improved.

Furthermore, when it is determined that the original file is revised, the user is urged to choose whether or not to reprint the selected data. Therefore, the user can recognize that the original file is revised and determine whether or not to print the old print data before revision. Utility of the print program is much more improved.

(Third Embodiment)

In the first and second embodiments, when there is equal to or more than a predetermined number of n of print data stored in the folder 2, the print data is removed in the order of oldness so that the number of print data stored in the folder 2 is less than the predetermined number of n. However, in the third embodiment, if there is the predetermined number of or more than n print data in the folder 2, the print data is removed in the order of reprint frequency so that the number of print data stored in the folder 2 is less than the predetermined number of n.

The third embodiment is only different from the first and the second embodiments except for the above point. Therefore, only the difference will be described hereinafter.

1. Print Process

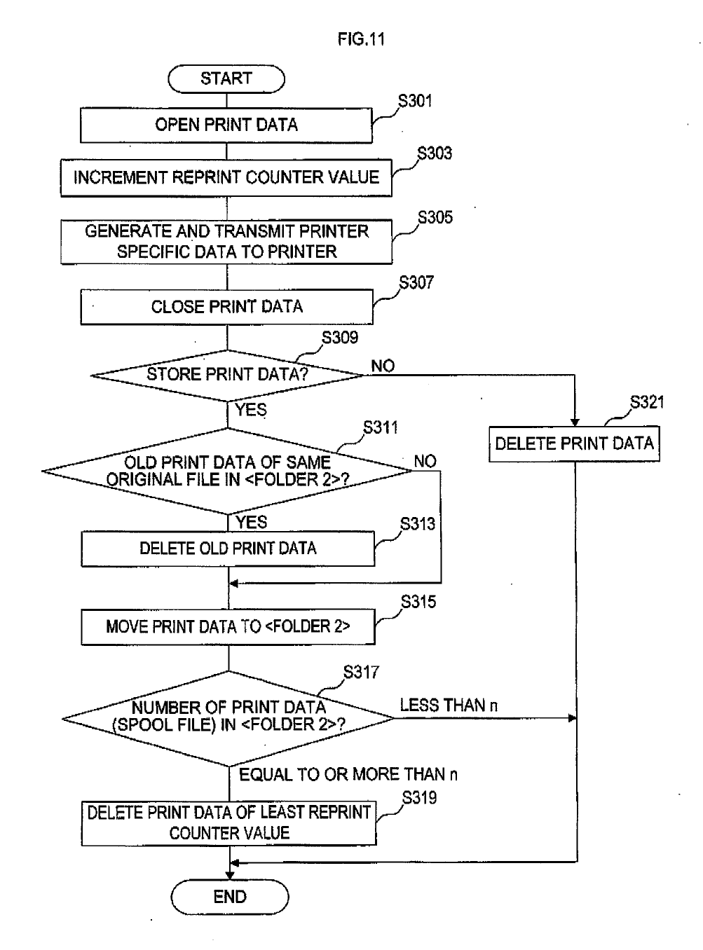

Referring to FIG. 11, when a print process according to the present embodiment is started, firstly the print data is opened (S301). A reprint counter value is incremented which indicates the number of reprints of the selected print data (S303). The print data is converted to the printer specific data and transmitted to the printer 20 (S305).

In the present embodiment, once the reprint counter value is incremented, the incremented reprint counter value is stored in a predetermined region on the HDD 16.

When the printer specific data is transmitted and printing is ended, the print data opened in S301 is closed (S307). It is then determined whether to store the print data after printed on the HDD 16 based on the selection on whether to store the print data set in the print setting window (S309).

When it is determined in S309 that the print data is to be stored (S309: YES), it is determined whether there is another print data already stored in the folder 2 which is generated based on the same original file of the print data to be stored (S311).

If it is positively determined in S311 (S311: YES), the another print data already stored in the folder 2 is removed (S313). The print data closed in S307 is moved from the folder 1 and stored in the folder 2 (S315).

Next, it is determined whether the print data stored in the folder 2 is equal to or more than the predetermined number of n (S317). If it is positively determined in S317, the print data is removed which has the smallest reprint counter value out of all the print data stored in the folder 2 (S319). The present control flow is ended. In S319, if there are a plurality of the print data having the smallest reprint counter value, at least one or all of those print data may be removed.

On the other hand, if it is negatively determined in S317 (S317: NO), none of the print data stored in the folder 2 is removed. The present control flow is ended.

If it is determined in S309 that the print data is not to be stored (S309: NO), the print data closed in S307is removed (S321). The present control flow is ended.

2. Characteristics of Print Program According to Third Embodiment

In the third embodiment, the print data is removed which has the small reprint counter value. Therefore, unnecessary accumulation of the print data of less reprint frequency can be avoided in the folder 2.

(Other Embodiments)

In the above embodiments, the relevant information associating the print data with the target data is used to automatically detect whether or not the target data (original file) has been revised. However, the relevant information may be used in various manners other than those shown in the above embodiments in order to improve usability of the print program.

In the above embodiments, the relevant information is created after generation of the print data. However, the relevant information may be created at various timings. For example, the relevant information may be created immediately after receipt of a command to print the print data from an application software, along with the print data. Or, the relevant information may be created at the time of determination on whether or not to remove the print data.

In the above embodiments, the relevant information and the print data together constitute a spool file. However, the relevant information and the print data may be stored as separate files.

Also, the relevant information and the print data may be stored not on the HDD 16 as in the above embodiments but on other storage media.

In the above embodiments, determination on whether to remove the print data is dependent on the selection in the print setting window (see S147 or S309). However, for example, the determination can be made such that the printed print data is removed when there is additional information attached to the original file that the original file is confidential.

Determination on whether to store the printed print data may not be made after printing as in the above embodiments but may be made before printing.

The print program may not be stored on the HDD 16 as in the above embodiments but on an information recording medium such as a CD-ROM (which are all considered computer-readable mediums).

The print program may be provided by using an information recording medium such as a CD-ROM (which are all considered computer-readable mediums) or provided by using information carrier such as an internet or a LAN (which are all considered computer-readable carriers).

In the above embodiments, revision of the original file is notified via the display unit 11. However, such notification may be made in a phonetic manner.

In the second embodiment, the choice is shown on the display unit 11 whether to open the original file in an application software by which the original file can be edited or to reprint the selected print data as is. However, for example, such choice can be notified to a user phonetically.

The present invention is not limited to the above embodiments. The present invention can be practiced in various manners without departing from the scope of the invention as defined in the appended claims.

What is claimed is:

1. A computer-readable medium storing a print program that makes a computer device function as
a print data generation module that creates print data based on target data to be stored on a storage unit, and
a relevant information generation module that creates relevant information that associates the target data with the print data, to be stored on the storage unit.

2. The computer-readable medium according to claim 1 wherein
the computer device is capable of being connected to a printer, and
the print program makes the computer device function as
a print module that transmits data necessary to execute a print process to the printer.

3. The computer-readable medium according to claim 1 wherein
the relevant information generation module creates and stores the relevant information in the storage unit when there is user input of a command to store the print data after printed.

4. The computer-readable medium according to claim 1 wherein
the relevant information generation module creates information including at least one of information on a file name of the target data and information on an application software by which the target data can be edited, as the relevant information.

5. The computer-readable medium according to claim 1 which makes the computer device function as
a primary data opening module that opens the target data in an editable manner in accordance with the relevant information.

6. The computer-readable medium according to claim 1 wherein
the computer device is capable of being connected to a printer, and
the print program makes the computer device function as
a reprint module that makes the printer reprint the print data.

7. The computer-readable medium according to claim 1 wherein
the relevant information generation module creates information on revised date and time of the target data as the relevant information.

8. The computer-readable medium according to claim 7 which makes the computer device function as
an original data revision information detecting module that detects the information on revised date and time of the target data corresponding to the print data selected to print, and
a revision determining module that determines whether the target data corresponding to the print data selected to print has been revised after creation of the print data, based on the information on revised date and time of the target data detected by the original data revision information detecting module and the relevant information created by the relevant information generation module.

9. The computer-readable medium according to claim 8 wherein
the computer device is capable of being connected to a printer, and
the print program makes the computer device function as
a non-revision reprinting module that makes the printer print the print data selected to print when it is determined that the target data has not been revised by the revision determining module.

10. The computer-readable medium according to claim 8 which makes the computer device function as
a secondary data opening module that opens the target data corresponding to the print data selected to print in an editable manner when it is determined that the target data has been revised by the revision determining module.

11. The computer-readable medium according to claim 8 which makes the computer device function as
an original data opening selection module that urges a user to select whether to open the target data corresponding to the print data selected to print in an editable manner when it is determined that the target data has been revised by the revision determining module.

12. The computer-readable medium according to claim 8 wherein
the computer device is capable of being connected to a printer, and
the print program makes the computer device function as
a reprint selection module that urges a user to select whether to make the printer print the print data selected to print when it is determined that the target data has been revised by the revision determining module.

13. The computer-readable medium according to claim 12 wherein
the reprint selection module notifies the user that the target data has been updated after creation of the print data when it is determined that the target data has been revised by the revision determining module.

14. The computer-readable medium according to claim 7 which makes the computer device to function as
a first print data removing module that removes the print data in an order of oldness so that a number of print data stored in the storage unit is less than a predetermined number.

15. The computer-readable medium according to claim 6 which makes the computer device function as
a reprint number counting module that makes the storage unit store reprint frequency of the print data stored in the storage unit, and
a second print data removing module that removes the print data of less reprint frequency so that a number of print data stored in the storage unit is less than a predetermined number.

16. The computer-readable medium according to claim 1 wherein
the computer device is capable of being connected to a printer, and
the print program makes the computer device function as
a removal determining module that determines whether to delete the print data after printed by the printer.

17. The computer-readable medium according to claim 1 which makes the computer device function as
a previewing module that provides advance viewing of a printed image of the print data on a display unit.

18. The computer-readable medium according to claim 8, wherein an output from the revision determining module is used to improve the usability of the print program.

19. A print system comprising
a computer device that includes a storage unit and is capable of being connected to a printer, and
a print program that is installed on the computer device and makes the computer device function as
a print data generation module that creates print data based on target data to be stored on the storage unit, and
a relevant information generation module that creates relevant information that associates the target data with the print data, to be stored on the storage unit.

20. A print program that makes a computer device function as
a print data generation module that creates print data based on target data to be stored on a storage unit, and
a relevant information generation module that creates relevant information that associates the target data with the print data, to be stored on the storage unit.

21. A computer-readable carrier carrying a print program that makes a computer device function as
a print data generation module that creates print data based on target data to be stored on a storage unit, and
a relevant information generation module that creates relevant information that associates the target data with the print data, to be stored on the storage unit.
